(19) United States
(12) Patent Application Publication
(10) Pub. No.: US 2009/0184655 A1
(43) Pub. Date: Jul. 23, 2009

(54) POWER MANAGEMENT SYSTEM FOR LIGHT EMITTING DIODES

(75) Inventors: Ira G. Miller, Tempe, AZ (US); Eduardo Velarde, Chandler, AZ (US)

Correspondence Address: LAW OFFICES OF MIKIO ISHIMARU, 333 W. EL CAMINO REAL, SUITE 330, SUNNYVALE, CA, 94087, US

(73) Assignee: MICREL, INC., San Jose, CA (US)

(21) Appl. No.: 12/017,474

(22) Filed: Jan. 22, 2008

(51) Int. Cl. H05B 37/02

(52) U.S. Cl. 315/291

(57) ABSTRACT

A power management system comprising: providing a one pin driver circuit; sourcing a managed current from the one pin driver circuit; and illuminating a light emitting diode by the managed current including reducing the managed current when the light emitting diode is not coupled.

### TECHNICAL FIELD

The present invention relates generally to power management systems, and more particularly to a system for managing the power for light emitting diodes.

### BACKGROUND ART

Light Emitting Diodes (LEDs) are extremely durable and efficient sources of light that can be found in many of our common electronic components, such as cameras, cellular telephones, personal music players, and wireless navigation devices. Recent developments in LED technology have resulted in components that can be combined into arrays having a brightness and light emission pattern comparable with light sources such as halogen bulbs and xenon flash tubes. Among other attractive characteristics such as durability and energy efficiency, LEDs have a very fast turn-on time of approximately 20 μS that is comparable with the turn on time of a xenon flash tube. If properly energized, an LED array can simulate the light-emission pattern of any pre-existing light source, including a xenon flash tube.

LEDs are solid-state components whose light output (luminous flux) increases in proportion to the applied forward current. However, excessive current through an LED generates heat that can damage the device. Each LED develops a forward voltage V_{F} that varies with the color of the LED as well as the ambient temperature. LED manufacturers typically rate each type of LED for continuous operation at an average forward current I_{Avg}. Each type of LED is also rated for momentary operation at a peak pulsed forward current Iₚₑₐₖ. Application of Iₚₑₐₖ to an LED produces increased brightness when compared to an LED energized by application of I_{Avg}. This peak brightness is particularly desirable in warning lights used in conjunction with emergency vehicles, aircraft, traffic signaling, etc. However, continuous application of Iₚₑₐₖ would result in excessive heat and damage or failure of the LED. There is a need in the art for LED driver circuits that permit precise control of the pattern and quantity of current applied to an LED or an LED array to produce a light emission pattern of appropriate intensity without overheating the LEDs.

It is desirable that each LED driver circuit generates the requisite controlled current over a range of output voltages to accommodate variation not only in the ambient temperature and the type of LED employed but also variation of the number of LEDs being driven. Constant current sources suitable for such an application are known in the art. One approach is to employ a chip called a switching regulator to control the applied current by varying the duty cycle of energy applied to the LEDs. The switching regulator is responsive to a current sensing circuit to control the applied current. In this manner, circuits can be configured to apply controlled currents to an LED over a range of output voltages. For example, a switching regulator configured as a buck converter circuit may be used to produce controlled current over a range of voltages less than the available input voltage, while a boost converter may be used to produce controlled current over a range of voltages greater than the available input voltage.

Maximum flexibility in terms of output voltage range allows a single driver circuit (also referred to as a ballast) to be used in conjunction with different numbers of LEDs of different types and over a range of ambient temperatures. Those of skill in the art will recognize that the design and manufacture of a driver circuit for each individual LED in an array or for each array having a particular number of LEDs is not cost-efficient. Therefore, there is a need in the art for multi-purpose LED driver circuits for energizing LED light sources that incorporate different numbers and/or types of LEDs.

Thus, a need still remains for a power management system for light emitting diodes. In view of the increasing demand and the requirement for efficient light sources, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a power management system including: providing a one pin driver circuit; sourcing a managed current from the one pin driver circuit; and illuminating a light emitting diode by the managed current including reducing the managed current when the light emitting diode is not coupled.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a circuit diagram of a power management system for light emitting diodes in an embodiment of the present invention;

FIG. 2 is a circuit diagram of the managed current source for light emitting diodes;

FIG. 3 is a schematic diagram of the amplifier of FIG. 2;

FIG. 4 is a schematic diagram of the current multiplier of FIG. 2.

FIG. 5 is a schematic diagram of the comparator of FIG. 2;

FIG. 6 is a schematic diagram of the digital interface of FIG. 2;

FIG. 7 is a plan view of an electronic device; and

FIG. 8 is a flow chart of a power management system for operating the power management system for light emitting diodes, in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs.

Where multiple embodiments are disclosed and described, having some features in common, for clarity and ease of illustration, description, and comprehension thereof, similar and like features one to another will ordinarily be described with like reference numerals. The embodiments may be numbered first embodiment, second embodiment, etc. as a matter of descriptive convenience and are not intended to have any other significance or provide limitations for the present invention.

For expository purposes, the term “on” as used herein means and refers to direct contact among elements. The term “processing” as used herein includes deposition of material, patterning, exposure, development, etching, cleaning, and/or removal of the material or trimming as required in forming a described structure. The term “system” as used herein means and refers to the method and to the apparatus of the present invention in accordance with the context in which the term is used.

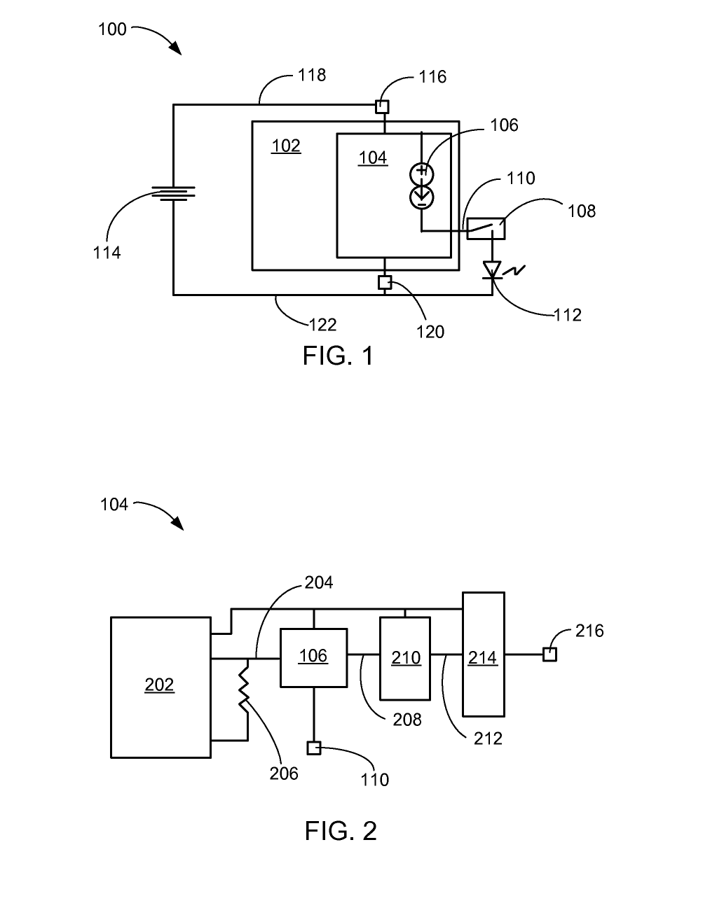

Referring now to FIG. 1, therein is shown a circuit diagram of a power management system 100 in a first embodiment of the present invention. The circuit diagram of the power management system 100 preferably includes a power management integrated circuit 102, such as an integrated circuit having power management circuitry, having a one pin driver circuit 104. The one pin driver circuit 104, including a managed current source 106, may be coupled to a switch 108 such as a mechanical switch, a push button switch, an electronic switch or a relay. The switch 108 may be connected to the managed current source 106 by a single driver line 110.

The switch 108 may also be connected to a light emitting diode 112 receiving power from a power source 114. The power source 114 can be connected to a first node 116 with a first voltage line 118 providing an electrical level such as power or VDD. The power source 114 can also be connected to a second node 120 with a second voltage line 122 providing an electrical level such as ground or VSS.

It has been unexpectedly discovered that the power management system 100 provides an indicator mode for the light emitting diode 112. The current driver having only one line, such as the single driver line 110, requiring only one pin resulting in significantly reduced current when the light emitting diode 112 is not attached to the one line or the one pin.

Referring now to FIG. 2, therein is shown a circuit diagram of the one pin driver circuit 104 for light emitting diodes. The circuit diagram of the one pin driver circuit 104 preferably includes an amplifier 202 such as a differential amplifier. The amplifier 202 can provide a current, such as a one hundred micro amp current, in a first current line 204. The amplifier 202 provides the current through a resistor 206. The resistor 206 provides a voltage such as a voltage of one fourth of a bandgap voltage.

The managed current source 106, such as a reference current multiplier, can be connected to the resistor 206. The managed current source 106 can provide scaling of the current provided by the amplifier 202. The scaled current may be coupled through the single driver line 110. A second current line 208 can connect the managed current source 106 to a comparator 210. The comparator 210 can detect a current provided by the managed current source 106. A status interface 212 may couple the comparator 210 to a digital interface 214. The digital interface 214 may provide a NO-LED status line 216 for detecting the state of the one pin driver circuit 104.

The managed current source 106 may receive a reference current in the range of 90 to 110 micro-Amps (μA) through the first current line 204. The managed current source 106 may then multiply the reference current by approximately 50, for producing a driver current in the range of 4.5 to 5.5 milli-Amps (mA). The driver current may be sourced through the single driver line 110 for activating the light emitting diode 112, of FIG. 1.

The second current line 208 provides a comparison current to the comparator 210 for detecting when the light emitting diode 112, of FIG. 1, is coupled to the single driver line 110. The status interface 212 may couple the comparator 210 to the digital interface 214. The digital interface 214 can convert the analog signals from the status interface 212 to the appropriate voltage levels to communicate the status to other digital control logic, not shown. The NO-LED status line 216 may be activated to indicate that the light emitting diode 112, of FIG. 1, is no longer connected to the single driver line 110. The NO-LED status line 216 can be connected to logic that signals mode indicator logic. For example, mode indicator logic can optionally provide an indication that a camera is about to take a picture.

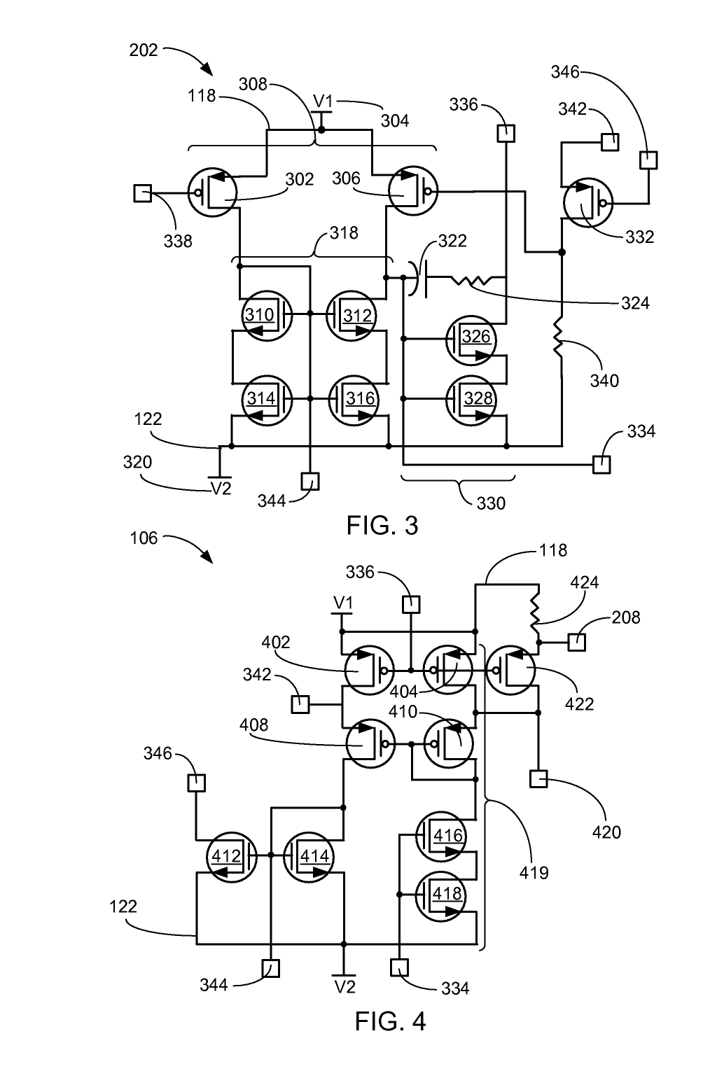

Referring now to FIG. 3, therein is shown a schematic diagram of the amplifier 202 of FIG. 2. The schematic diagram of the amplifier 202 preferably includes a first P-channel transistor 302, such as a metal oxide semiconductor field effect transistor (MOSFET), a bipolar junction transistor (BJT), or a junction field effect transistor (JFET), coupled to the first voltage line 118 providing a first electrical level (V1) 304 such as power or VDD. A second P-channel transistor 306, of a substantially similar type as the first P-channel transistor 302 may also be coupled to the first voltage line 118. The first P-channel transistor 302 and the second P-channel transistor 306 are configured to form an input and an output, respectively of a differential amplifier 308.

A first N-channel transistor 310, such as a metal oxide semiconductor field effect transistor (MOSFET), a bipolar junction transistor (BJT), or a junction field effect transistor (JFET), may be coupled to a second N-channel transistor 312, a third N-channel transistor 314, and a fourth N-channel transistor 316 for forming a cascode current mirror 318. The cascode current mirror 318 provides a reference current from a highly stable source for the differential amplifier 308. The cascode current mirror 318 may be coupled to the second voltage line 122 providing a second electrical level (V2) 320, such as ground or VSS.

A capacitor 322 and a first resistor 324 may be coupled and connected to the cascode current mirror 318. A fifth N-channel transistor 326 and a sixth N-channel transistor 328 may be connected in a cascade configuration. The capacitor 322 and the first resistor 324 are coupled across the fifth N-channel transistor 326 and the sixth N-channel transistor 328 for forming a compensation network 330 that may control the activation of the managed current source 106, of FIG. 1. An amplifier output 334 may be for use in other circuits (not shown). A gated voltage node 336 may be used to enable the compensation network 330 and the reference current circuits.

A reference voltage node 338 may be coupled to the first P-channel transistor 302 for activating the differential amplifier 308. The second P-channel transistor 306 may be coupled to a second resistor 340 for setting a reference current of approximately 100 μA that may be gated by the third P-channel transistor 332. When the third P-channel transistor 332 is enabled it may pass the feedback current from a feedback current node 342.

A circuit off node 344 may be used to cause the circuit to switch to an alternate mode. The alternate mode may switch the circuitry off in order to save energy. This is essential in a battery operated device, such as a camera, cell phone, or other electronic device. A controlled current node 346 may be used to reduce the current consumption when the amplifier is not in use.

Referring now to FIG. 4, therein is shown a schematic diagram of the managed current source 106. The schematic diagram of the managed current source 106 preferably includes a first P-channel transistor 402, such as a metal oxide semiconductor field effect transistor (MOSFET), a bipolar junction transistor (BJT), or a junction field effect transistor (JFET), coupled to the first voltage line 118 providing the first electrical level (V1) 304 such as power or VDD. A second P-channel transistor 404, of a substantially similar type as the first P-channel transistor 402 may also be coupled to the first voltage line 118. The gated voltage node 336 may be connected to the gates of the first P-channel transistor 402 and the second P-channel transistor 404. The gated voltage node 336 may be used for activating the current through the second P-channel transistor 404. The feedback current node 342 may be coupled between the first P-channel transistor 402 and a third P-channel transistor 408 for multiplying the reference current.

The third P-channel transistor 408 may be coupled to a fourth P-channel transistor 410, a first N-channel transistor 412, and a second N-channel transistor 414. The first N-channel transistor 412 may be coupled to the controlled current node 346, the second N-channel transistor 414, and the second voltage line 122. The circuit off node 344 may be activated for turning off the managed current source 106. A third N-channel transistor 416 and a fourth N-channel transistor 418 are both gated by the amplifier output 334 for controlling the activation of a light emitting diode driver node 420.

The third N-channel transistor 416 and the fourth N-channel transistor 418 are configured in a cascade fashion while being coupled to the second voltage line 122 at the source of the fourth N-channel transistor 418. The third N-channel transistor 416 may be connected to the fourth P-channel transistor 410, forming a current multiplier 419 capable of sourcing approximately a 5 mA current through the second P-channel transistor 404 to the light emitting diode driver node 420.

A fifth P-channel transistor 422 may monitor the current that is sent to the light emitting diode driver node 420 through the second P-channel transistor 404. A current limiting resistor 424 may be coupled between the first voltage line 118 and the fifth P-channel transistor 422. The current limiting resistor 424 may also provide a sample current to the second current line 208 for comparing the current.

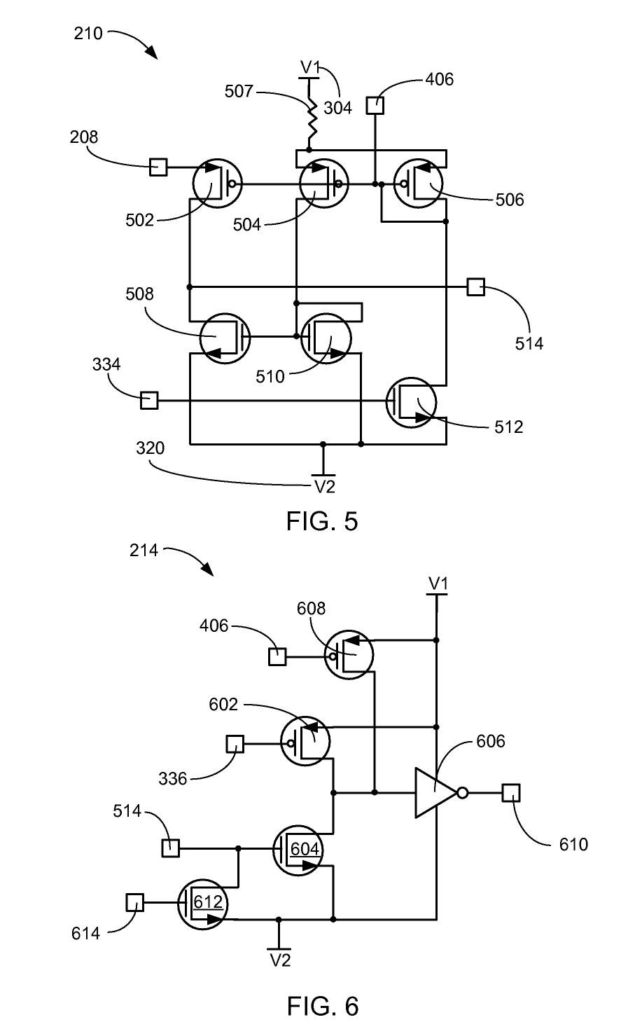

Referring now to FIG. 5, therein is shown a schematic diagram of the comparator 210 of FIG. 2. The schematic diagram of the comparator 210 preferably includes a first P-channel transistor 502, such as a metal oxide semiconductor field effect transistor (MOSFET), a bipolar junction transistor (BJT), or a junction field effect transistor (JFET), having the source coupled to the second current line 208. The first P-channel transistor 502 may have its gate coupled to the gates of a second P-channel transistor 504 and a third P-channel transistor 506. A current limiting resistor 507 may be coupled between the first electrical level (V1) 304 and the sources of the second P-channel transistor 504 and the third P-channel transistor 506.

A first N-channel transistor 508, such as a metal oxide semiconductor field effect transistor (MOSFET), a bipolar junction transistor (BJT), or a junction field effect transistor (JFET), and a second N-channel transistor 510 may be coupled in order to form a current mirror for monitoring the second current line 208. A third N-channel transistor 512 may be used to delay the comparison before the timer output 334 is asserted. If the current on the second current line 208 is less than the current established through the second P-channel transistor 504 and the second N-channel transistor 510, a light emitting diode removed signal 514 may be activated. The sources of the first N-channel transistor 508, the second N-channel transistor 510, and the third N-channel transistor 512 may be coupled to the second electrical level (V2) 320.

Referring now to FIG. 6, therein is shown a schematic diagram of the digital interface 214. The schematic diagram of the digital interface 214 preferably includes a first P-channel transistor 602, such as a metal oxide semiconductor field effect transistor (MOSFET), a bipolar junction transistor (BJT), or a junction field effect transistor (JFET), coupled to a first N-channel transistor 604. The first P-channel transistor 602 and the first N-channel transistor 604 form a level converter for input to a digital inverter 606. The controlled current node 346 may activate the first P-channel transistor 602. A second P-channel transistor 608 may be used to activate the digital inverter 606. The light emitting diode removed signal 514 may be coupled to the gate of the first N-channel transistor 604 for deactivating the input if the digital inverter 606.

The reference voltage node 336 may be coupled to the gate of the second P-channel transistor 608. The second P-channel transistor 608 may act as a weak pull-up on the input of the digital inverter 606.

A no light emitting diode connected node 610 may act as an indicator to the power management integrated circuit 102 that the light emitting diode 112, of FIG. 1, is no longer connected to the single driver line 110, of FIG. 1. The power management integrated circuit 102 may then activate a second N-channel transistor 612 by asserting a circuit power down node 614.

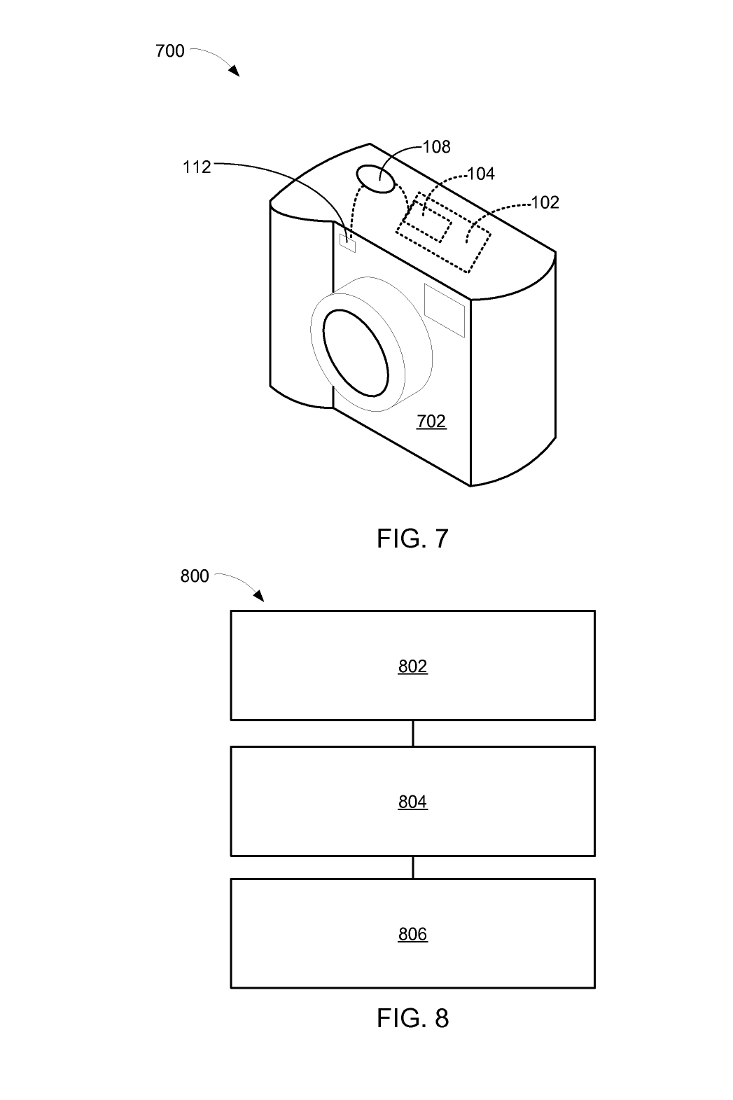

Referring now to FIG. 7, therein is shown a plan view of an electronic device 700. The plan view of the electronic device 700, such as a digital camera, preferably includes the light emitting diode 112 mounted in an electronic device body 702. The power management integrated circuit 102, having the one pin driver circuit 104 may be coupled to the switch 108. The switch 108, such as a push button switch, may temporarily couple the one pin driver circuit 104 to the light emitting diode 112 as a warning that a picture is about to be taken. This is useful in a timed exposure where the camera may take a picture a set time after the switch 108 is activated.

When the picture has been exposed, the switch 108 may disconnect the light emitting diode 112 from the one pin driver circuit 104. When the light emitting diode 112 is disconnected from the one pin driver circuit 104 an alternate mode of operation is performed by the one pin driver circuit 104. During the alternate mode of operation the circuit power down node 614, of FIG. 6, may be activated causing the circuit off node 344, of FIG. 3, to become active. This reduces the power consumption of the one pin driver circuit 104 from 5 to 10 mA to a range of 2 to 20 μA. This process may extend the available battery life of the electronic device 700 allowing longer functional availability and more pictures to be taken.

Referring now to FIG. 8, therein is shown a flow chart of a power management system 800 for manufacturing the power management system 100 in an embodiment of the present invention. The system 800 includes providing a one pin driver circuit in a block 802; sourcing a managed current from the one pin driver circuit in a block 804; and illuminating a light emitting diode by the managed current including reducing the managed current when the light emitting diode is not coupled in a block 806.

In greater detail, the system 800 to provide the method and apparatus of the power management system 100, in an embodiment of the present invention, is performed as follows:

Providing a light emitting diode including providing an electronic device body for mounting the light emitting diode. (FIG. 1) and

Coupling a one pin driver circuit to the light emitting diode including: forming an amplifier for providing a reference current on a first current line, coupling a comparator to the managed current source for comparing a second current line, and activating a digital interface by the comparator including signaling a power management integrated circuit for asserting a circuit power down node. (FIG. 2)

Thus, it has been discovered that the power management system method and apparatus of the present invention furnish important and heretofore unknown and unavailable solutions, capabilities, and functional aspects. The resulting processes and configurations are straightforward, cost-effective, uncomplicated, highly versatile, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

What is claimed is:

1. A power management system comprising:
providing a one pin driver circuit;
sourcing a managed current from the one pin driver circuit; and
illuminating a light emitting diode by the managed current including reducing the managed current when the light emitting diode is not coupled.

2. The system as claimed in claim 1 further comprising coupling a digital interface to the one pin driver circuit.

3. The system as claimed in claim 1 further comprising providing an amplifier for referencing the managed current.

4. The system as claimed in claim 1 further comprising forming a power management integrated circuit for switching an alternate mode in the one pin driver circuit.

5. The system as claimed in claim 1 further comprising forming an electronic device having the one pin driver circuit coupled to the light emitting diode.

6. A power management system comprising:
providing a light emitting diode including providing an electronic device body for mounting the light emitting diode; and
coupling a one pin driver circuit to the light emitting diode including:
forming an amplifier for providing a reference current on a first current line,
coupling a managed current source to the amplifier including providing a current multiplier,
coupling a comparator to the managed current source for comparing a second current line, and
activating a digital interface by the comparator including signaling a power management integrated circuit for asserting a circuit power down node in the one pin driver circuit.

7. The system as claimed in claim 6 further comprising coupling a switch between the one pin driver circuit and the light emitting diode in which coupling the switch includes coupling a push button switch.

8. The system as claimed in claim 6 further comprising forming a cascode current mirror in the amplifier in which forming the cascode current mirror includes providing the reference current in the range of 90 to 110 micro-Amps.

9. The system as claimed in claim 6 further comprising forming a power management integrated circuit for switching an alternate mode in the managed current source including reducing a power consumption of the one pin driver circuit to the range of 2 to 20 micro-Amps.

10. The system as claimed in claim 6 further comprising forming an electronic device having the one pin driver circuit coupled to the light emitting diode including forming a power management integrated circuit for controlling the one pin driver circuit.

11. A power management system comprising:
a light emitting diode; and
a one pin driver circuit coupled to the light emitting diode including:
a managed current source, and
a comparator coupled to the managed current source.

12. The system as claimed in claim 11 further comprising a digital interface coupled to the comparator.

13. The system as claimed in claim 11 further comprising an amplifier for referencing the managed current source.

14. The system as claimed in claim 11 further comprising a power management integrated circuit to activate an alternate mode in the managed current source.

15. The system as claimed in claim 11 further comprising an electronic device having the one pin driver circuit coupled to the light emitting diode.

16. The system as claimed in claim 11 further comprising:
an electronic device body having the light emitting diode mounted;
an amplifier coupled to the managed current source;
a first current line coupled to the amplifier;
a current multiplier in the managed current source;
a second current line between the managed current source and the comparator;
a digital interface coupled to the comparator; and
a power management integrated circuit coupled to the digital interface for asserting a circuit power down node.

17. The system as claimed in claim 16 further comprising a switch between the one pin driver circuit and the light emitting diode in which the switch includes a push button switch.

18. The system as claimed in claim 16 further comprising a cascode current mirror in the amplifier in which the cascode current mirror provides the reference current in the range of 90 to 110 micro-Amps.

19. The system as claimed in claim 16 further comprising a timer in the amplifier includes the current multiplier allowed to stabilize before the reference current is gated.

20. The system as claimed in claim 16 further comprising an electronic device having the one pin driver circuit coupled to the light emitting diode includes the power management integrated circuit for controlling the one pin driver circuit.
